(19) United States
(12) Patent Application Publication
(10) Pub. No.: US 2012/0078966 A1
(43) Pub. Date: Mar. 29, 2012

(54) File System With Content Identifiers

(75) Inventors: Bowen L. Alpern, Hawthorne, NY (US); Glenn S. Ammons, Dobbs Ferry, NY (US); Vasanth Bala, Rye, NY (US); Todd W. Mummert, Danbury, CT (US); Darrell C. Reimer, Tarrytown, NY (US); Jian Yin, Richland, WA (US); Xiaolan Zhang, Dobbs Ferry, NY (US)

(73) Assignee: INTERNATIONAL BUSINESS MACHINES CORPORATION, Armonk, NY (US)

(21) Appl. No.: 12/893,099

(22) Filed: Sep. 29, 2010

(51) Int. Cl. G06F 17/30

(52) U.S. Cl. 707/790; 707/E17.005

(57) ABSTRACT

A method for operating a file system includes receiving a write instruction including a file descriptor associated with a file and a content identifier, a content offset, and a content length, associating a region within the file with the content identifier, saving the association of the region and the content identifier.

### BACKGROUND

The present invention relates to file systems, and more specifically, to file systems where file data is stored in a content-addressable store.

Many file systems include redundant data files that are shared amongst file systems to reduce the use of data storage space. For example, in data backup operations, a file system may store data from a particular time period. When the data is backed up a second time, the system may recognize the similar data, and store only the differences between the two backups—reducing the use of data storage space.

Another method for reducing the storage of redundant data is to store files or data blocks in a content-addressable store (CAS). The CAS assigns content identifiers to data such that if the portions of data are identical, the portions of data will have the same content identifier. A file system may be formatted as a map or table that associates data files or data blocks (content) with content identifiers. If, for example, two file systems share data, their maps will share content identifiers. Since content identifiers are typically much smaller than the associated content, the use of content identifiers saves data storage space.

Methods and systems that offer decreased read and write times and an improved user interface are desired.

### BRIEF SUMMARY

According to one embodiment of the present invention, a method for operating a file system includes receiving a write instruction including a file descriptor associated with a file and a content identifier, a content offset, and a content length, associating a region within the file with the content identifier, saving the association of the region and the content identifier.

According to another embodiment of the present invention, a method for operating a file system includes receiving a read instruction including a file descriptor and a file descriptor offset, retrieving a content identifier, a content offset, and a content length associated with the file descriptor, and outputting the content identifier, the content offset, and the content length.

According to yet another embodiment of the present invention a system for administering a file system includes a memory operative to store data, and a processor operative to receive a write instruction including a file descriptor associated with a file and a content identifier, a content offset, and a content length, associate a region within the file with the content identifier, save the association of the region and the content identifier.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an exemplary embodiment of a system.

FIGS. 2A-2B illustrate an exemplary embodiment of a file system.

FIG. 3 illustrates an exemplary block diagram for implementing a write instruction.

FIG. 4 illustrates an exemplary block diagram for implementing a read instruction.

FIGS. 5A-5B illustrate an alternate exemplary embodiment of a file system.

FIG. 6 illustrates an exemplary block diagram for implementing a write instruction.

FIG. 7 illustrates an exemplary block diagram for implementing a read instruction.

### DETAILED DESCRIPTION

The illustrated exemplary embodiments described below offer methods and systems that expose a file-to-content-identifier map through an extended file system interface decreasing read and write times and offering an improved file system interface.

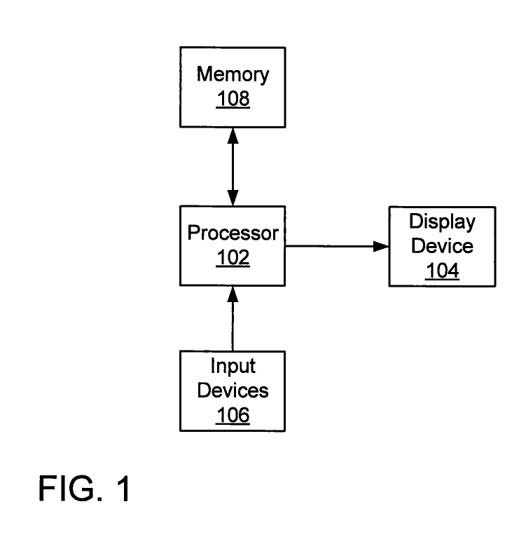

In this regard, FIG. 1 illustrates an exemplary embodiment of a system 100 that may be used to organize and administer a file system. The system 100 includes a processor 102 that is communicatively linked to a display device 104, input devices 106, and a memory 108 that may include a database.

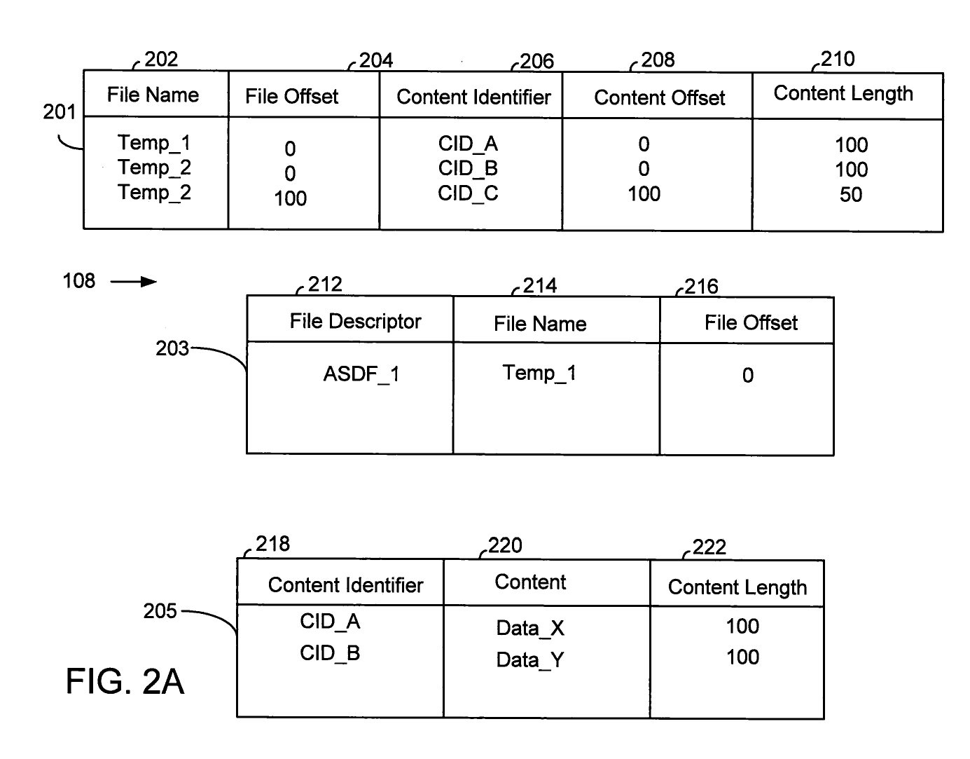

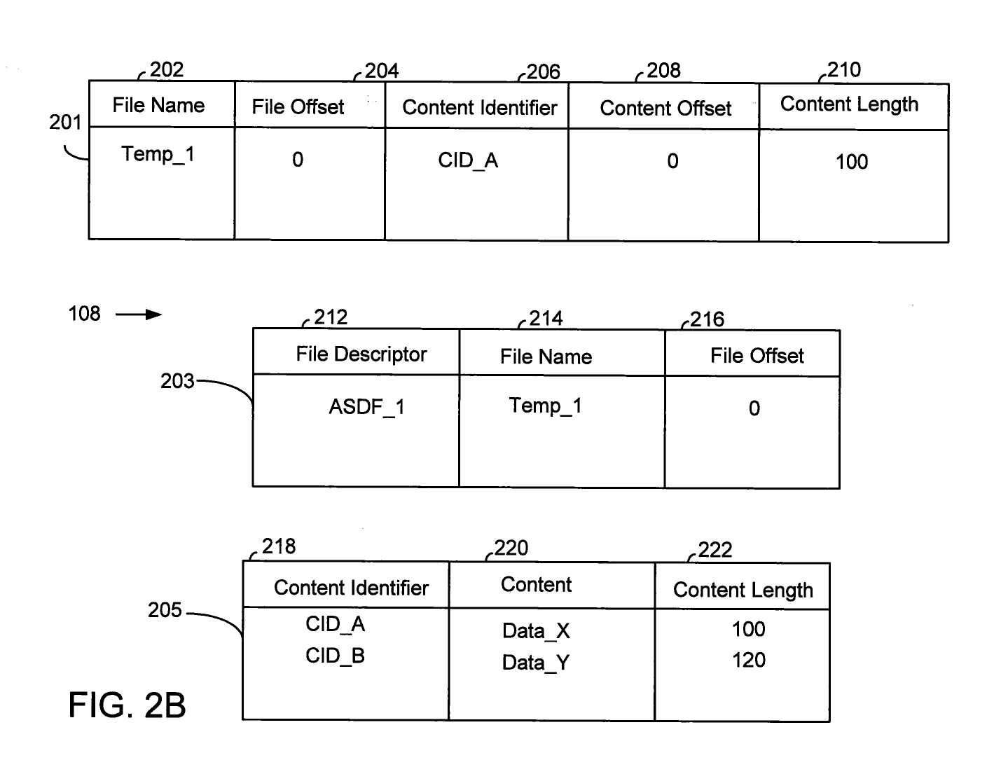

FIG. 2A illustrates an exemplary embodiment of a file system including a file name to content identifier (content ID) table 201, a file descriptor to file name table 203, and a content ID to data table 205 the tables may be, for example, stored in a database or the memory 108. The table 201 includes filename 202 (an identifier of a data file), and associated file offset 204 (a position of the file in an array of bits), content identifier 206 (a unique identifier of an item in a content-addressable store), content offset 208 (a position within the item), and content length (the length of the item's data, starting at the content offset, that is associated with the filename 202 and file offset 204) entries. The table 203 includes file descriptor 212 (a temporary name associated with the file name), file name 214, and file offset 216 entries. The table 205 represents the content-addressable store and includes content identifier 218, content 220 (an item's data) and associated content length 222 entries.

FIG. 2B is similar to FIG. 2A and illustrates the operation of the system, which will be explained in further detail below.

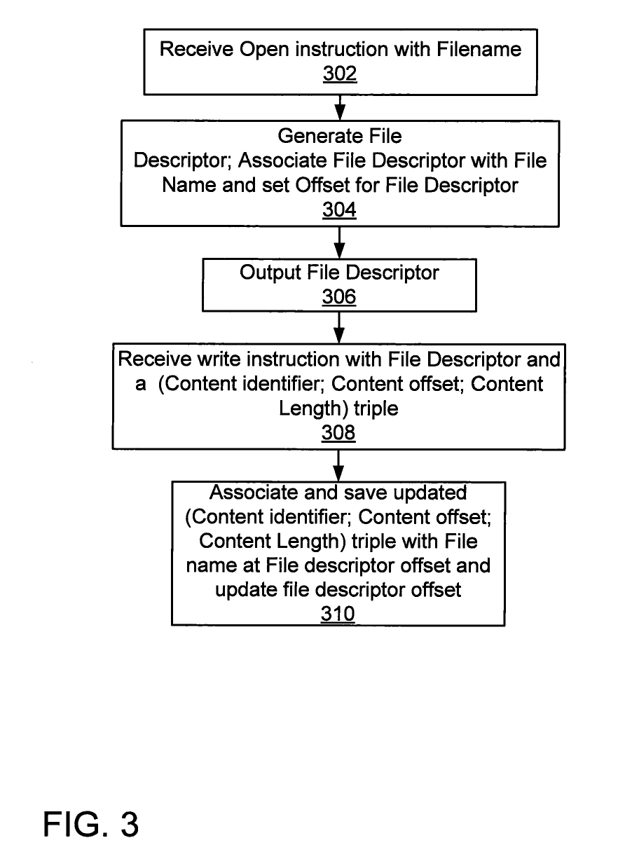

FIG. 3 illustrates an exemplary block diagram for implementing a write instruction using the file system described in FIGS. 2A and 2B and the system 100 (of FIG. 1). In block 302, an open instruction that includes a file name is received. A file descriptor and file offset are generated and associated with the filename in table 203 (FIG. 2A) in block 304. In block 306, the file descriptor (of table 203; FIG. 2A) is output. In block 308, a write instruction is received that includes the file descriptor, a content identifier, a content offset, and a content length. In block 310, the received content identifier, content offset, and content length is associated with the file name in table 201 (of FIG. 2B) and saved in the memory 108, and the offset of the file descriptor is updated to point immediately beyond the written region.

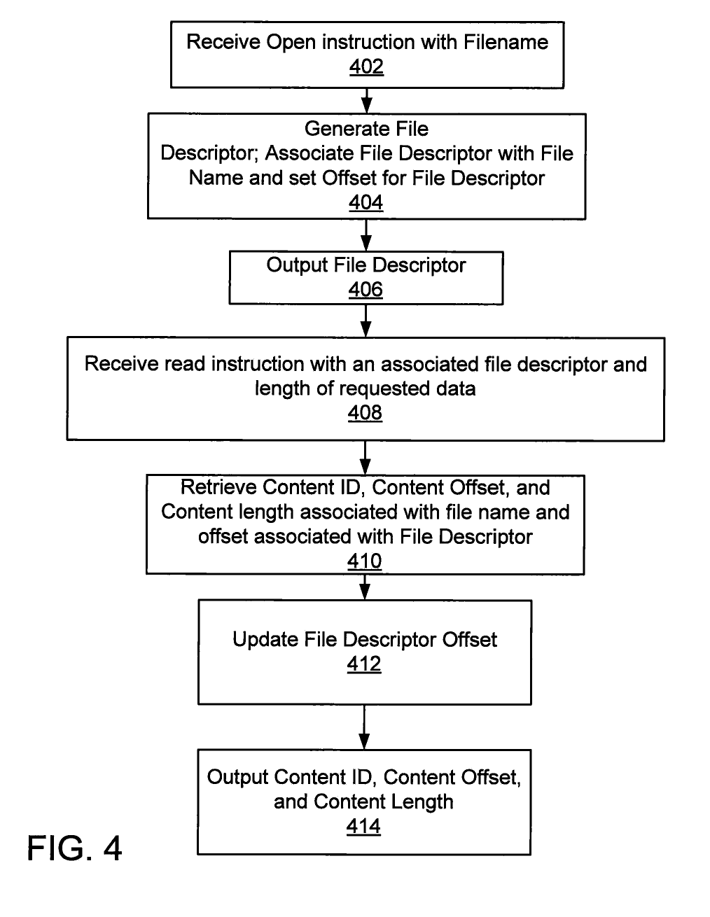

FIG. 4 illustrates an exemplary block diagram for implementing a read instruction using the file system described in FIGS. 2A and 2B and the system 100 (of FIG. 1). In block 402, a read instruction that includes a filename is received. In block 404, a file descriptor and file offset are generated and associated with the filename in table 203 (FIG. 2B), and the file that is associated with the filename may be opened. The file descriptor is output in block 406. In block 408, a read instruction is received that includes the file descriptor and a length. The content ID, offset, and length associated with the file descriptor, file name, and the file offset in table 201 are retrieved in block 410. In block 412, the offset of the file descriptor is updated to point just beyond the region read. The content ID, offset, and length are output in block 414.

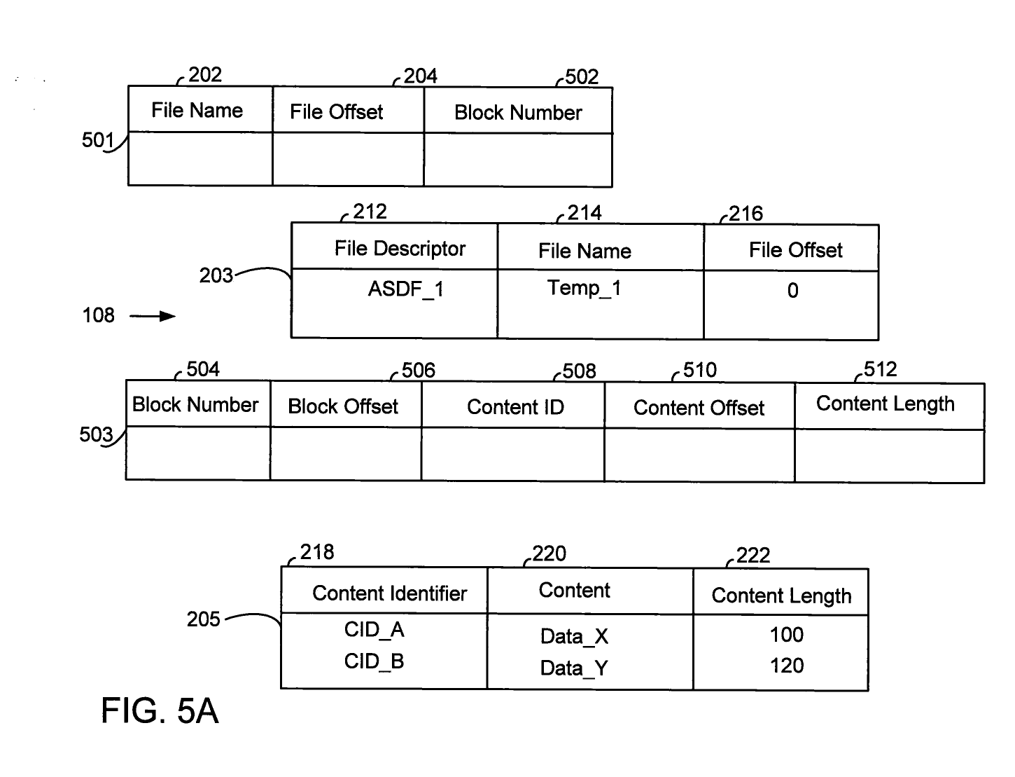

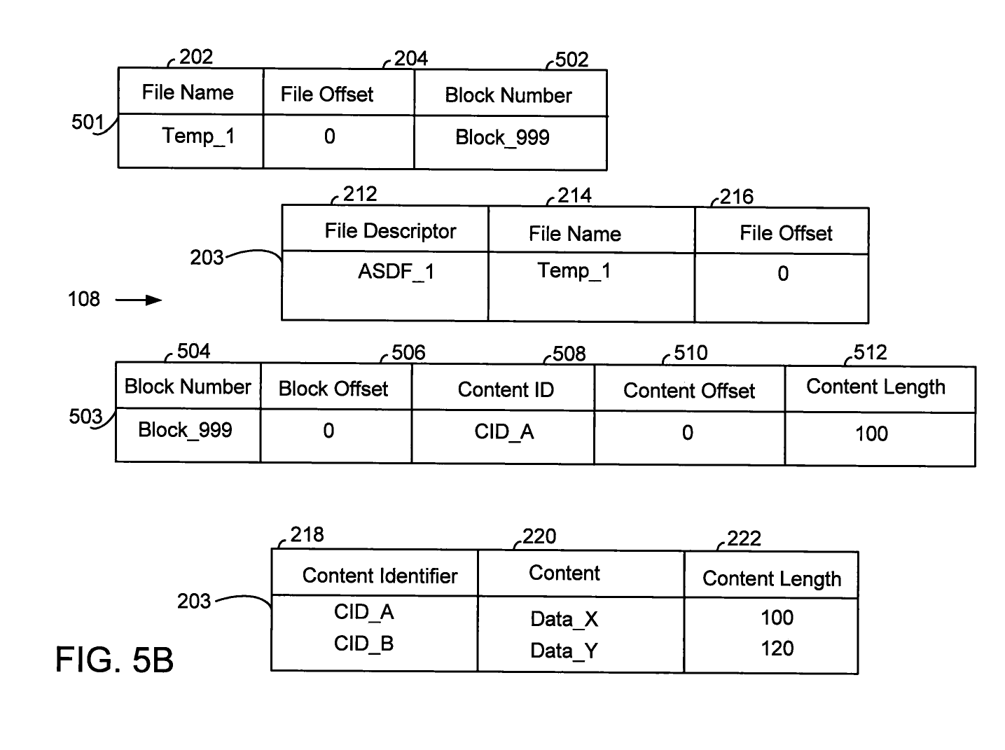

FIG. 5A illustrates an alternate exemplary embodiment of a file system including a file name to block number table 501, a file descriptor to file name table 203, and a block number to content ID table 503, and a content ID to data table 205. The table 501 includes file name 202, file offset 204, and block number 502 (an identified block in an array of blocks) entries. The table 203 includes file descriptor 212, file name 214, and file offset 216 entries. The table 503 includes block number 504, block offset 506 (a position of data in a block), content ID 508, content offset 510, and content length 512 entries. The table 205 includes content identifier 218, content 220 and associated content length 222 entries.

FIG. 5B is similar to FIG. 5A and illustrates the operation of the system, which will be explained in further detail below.

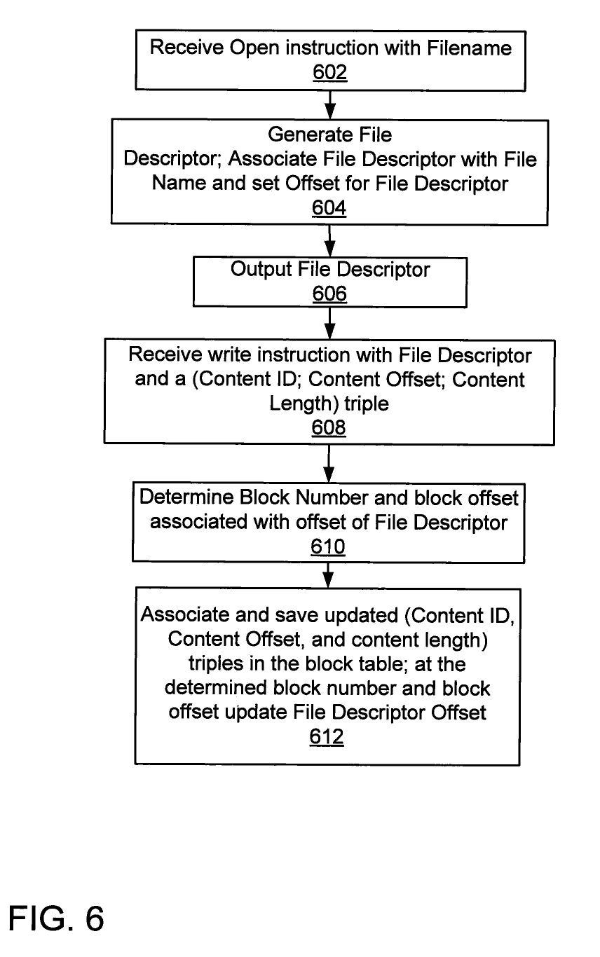

FIG. 6 illustrates an exemplary block diagram for implementing a write instruction using the file system described in FIGS. 5A and 5B and the system 100 (of FIG. 1). In block 602, an open instruction that includes a file name is received. A file descriptor and file offset are generated and associated with the filename in table 203 (FIG. 5A) in block 604. In block 606, the file descriptor (of table 203; FIG. 5A) is output. In block 608, a write instruction is received that includes the file descriptor, a content identifier, a content offset, and a content length. The block number associated with the file descriptor filename and file offset (from tables 501 and 203 of FIG. 5A) is determined in block 610. In block 612, the block table 503 is updated with the received content ID, offset, and length and saved in the memory 108. The file descriptor's offset is updated to point just beyond the written region.

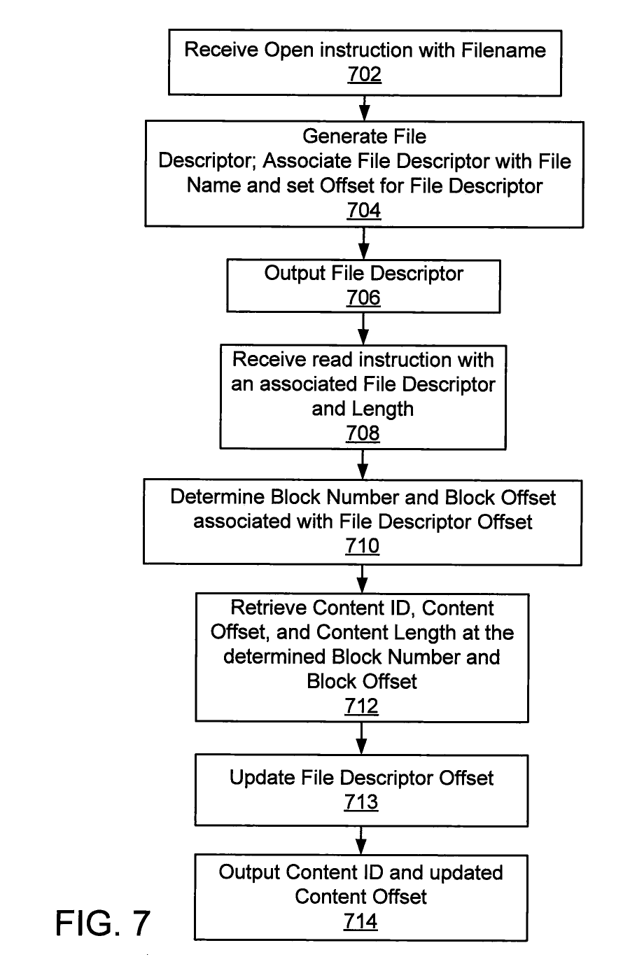

FIG. 7 illustrates an exemplary block diagram for implementing a read instruction using the file system described in FIGS. 5A and 5B and the system 100 (of FIG. 1). In block 702, an open instruction that includes a filename is received. In block 704, a file descriptor and file offset are generated and associated with the filename in table 203 (FIG. 5B), and the file that is associated with the filename may be opened. The file descriptor is output in block 706. In block 708, a read instruction is received that includes the file descriptor and a content length. The block number and block offset that are associated with the file descriptor filename and offset is retrieved from table 501 (of FIG. 5A) in block 710. In block 712, the content ID, offset, and length associated with the block number and block offset is retrieved from table 503 (of FIG. 5A). In block 713, the file descriptor offset is updated to point just beyond the read region of the file. In block 714, the content ID, offset, and length retrieved in block 712 is output.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for operating a file system, the method including:
receiving a write instruction including a file descriptor associated with a file and a content identifier, a content offset, and a content length;
associating a region within the file with the content identifier;
saving the association of the region and the content identifier.

2. The method of claim 1, wherein the region in the file is identified with a file descriptor offset.

3. The method of claim 1, wherein the region within the file is further associated with the content offset and the content length, and the association of the region and the content offset and the content length is saved.

4. The method of claim 2, wherein the method further includes determining a block number and block offset associated with the file descriptor offset.

5. The method of claim 4, wherein the association of the region and the content identifier are saved at the determined block number and block offset.

6. The method of claim 1, wherein the method further includes receiving an open instruction prior to receiving the write instruction.

7. The method of claim 6, wherein the method further includes:
generating the file descriptor, responsive to receiving the open instruction;
associating the file descriptor with a file name; and
setting a file descriptor offset.

8. A method for operating a file system, the method including:
receiving a read instruction including a file descriptor and a file descriptor offset;
retrieving a content identifier, a content offset, and a content length associated with the file descriptor; and
outputting the content identifier, the content offset, and the content length.

9. The method of claim 8, wherein the file descriptor is associated with a file name.

10. The method of claim 8, wherein the method further includes updating the file descriptor offset prior to outputting the content identifier, the content offset, and the content length.

11. The method of claim 8, wherein the method further includes determining a block number and a block offset associated with the file descriptor offset responsive to receiving the read instruction.

12. The method of claim 11, wherein the content identifier, the content offset, and the content length associated with the file descriptor are retrieved at the determined block number and block offset.

13. A system for administering a file system including:
a memory operative to store data; and
a processor operative to receive a write instruction including a file descriptor associated with a file and a content identifier, a content offset, and a content length, associate a region within the file with the content identifier, save the association of the region and the content identifier.

14. The system of claim 13, wherein the processor is further operative to determine a block number and block offset associated with the file descriptor offset.

15. The system of claim 14, wherein the association of the region and the content identifier are saved at the determined block number and block offset.

16. The system of claim 13, wherein the processor is further operative to receive a read instruction including a file descriptor and a file descriptor offset, retrieve a content identifier, a content offset, and a content length associated with the file descriptor, and output the content identifier, the content offset, and the content length.

17. The system of claim 16, wherein the processor is further operative to determine a block number and a block offset associated with the file descriptor offset responsive to receiving the read instruction.

18. The method of claim 17, wherein the content identifier, the content offset, and the content length associated with the file descriptor are retrieved at the determined block number and block offset.
